(19) United States
(12) Patent Application Publication
(10) Pub. No.: US 2019/0369847 A1
(43) Pub. Date: Dec. 5, 2019

(54) IMAGE DISPLAY APPARATUS AND OPERATING METHOD OF THE SAME

(71) Applicant: SAMSUNG ELECTRONICS CO., LTD., Suwon-si (KR)

(72) Inventors: Hana KIM, Suwon-si (KR); Soohong Kim, Suwon-si (KR)

(73) Assignee: SAMSUNG ELECTRONICS CO., LTD., Suwon-si (KR)

(21) Appl. No.: 16/407,524

(22) Filed: May 9, 2019

(30) Foreign Application Priority Data
Jun. 1, 2018 (KR) 10-2018-0063757

(51) Int. Cl. G06F 3/0484; G06T 7/73; G06T 3/40

(52) U.S. Cl. CPC G06F 3/04845; G06F 3/04847; G06T 3/40; G06T 7/73

(57) ABSTRACT

Provided are an image display apparatus and an operating method of the same. The image display apparatus includes a display displaying image content, a memory storing one or more instructions; and a processor configured to execute the one or more instructions stored in the memory, and the processor is configured to execute the one or more instructions to acquire actual size information of at least one object included in the image content and to control the display to display the at least one object in its actual size based on the actual size information.

### CROSS-REFERENCE TO RELATED APPLICATION

This application is based on and claims priority under 35 U.S.C. § 119 to Korean Patent Application No. 10-2018-0063757, filed on Jun. 1, 2018, in the Korean Intellectual Property Office, the disclosure of which is incorporated by reference herein in its entirety.

### BACKGROUND

### 1. Field

The disclosure relates to an image display apparatus and an operating method of the same, and more particularly, to an image display apparatus capable of displaying at least one object included in image content in its actual size, and an operating method of the image display apparatus.

### 2. Description of Related Art

An image display apparatus is an apparatus having a function of displaying images a user can watch. A user can watch broadcasting through the image display apparatus. The image display apparatus displays broadcasting selected by a user from among broadcast signals sent from a broadcasting station on a display.

Also, a smart TV that provides various contents in addition to a broadcast function has come into widespread use. The smart TV is aimed at analyzing what a user wants and providing the user's desired content without the user's operation instead of being manually operated according to the user's selection.

Meanwhile, because the image display apparatus displays objects included in image content in proportion to the size of the display without reference to their actual sizes, in some specific cases, the image display apparatus cannot properly give a sense of reality.

### SUMMARY

Provided are an image display apparatus capable of displaying at least one object included in image content in its actual size, and an operating method of the image display apparatus.

Additional aspects will be set forth in part in the description which follows and, in part, will be apparent from the description, or may be learned by practice of the presented embodiments of the disclosure.

According to an embodiment of the disclosure, an image display apparatus includes a display displaying image content, a memory storing one or more instructions, and a processor configured to execute the one or more instructions stored in the memory, and the processor is configured to execute the one or more instructions to acquire actual size information of at least one object included in the image content and to control the display to display the at least one object in its actual size based on the actual size information.

The processor according to an embodiment of the disclosure may be further configured to execute the one or more instructions to perform image analysis to determine a kind of the at least one object, and acquire the actual size information of the at least one object based on the kind of the at least one object.

The processor according to an embodiment of the disclosure may be further configured to execute the one or more instructions to perform image analysis to detect an image that is similar to the at least one object from among one or more images stored together with actual size information, and extract the actual size information of the at least one object based on actual size information corresponding to the detected image.

The processor according to an embodiment of the disclosure may be further configured to execute the one or more instructions to perform image analysis to extract the actual size information of the at least one object in the image content.

The processor according to an embodiment of the disclosure may be further configured to execute the one or more instructions to receive an image in which the at least one object and a reference object are imaged together, and determine an actual size of the at least one object based on actual size information of the reference object and the received image.

The reference object may include one or more screen markers that are displayed on the display, and the processor may be further configured to execute the one or more instructions to set sizes of the one or more screen markers and positions of the one or more screen markers that are to be displayed on the display.

The processor according to an embodiment of the disclosure may be further configured to execute the one or more instructions to receive a user input of selecting an actual size display mode, and control the display to display the at least one object included in the image content in the actual size.

The processor according to an embodiment of the disclosure may be further configured to execute the one or more instructions to acquire the actual size information of the at least one object based on a user input; and control the display to display the at least one object in the actual size according to the actual size information acquired based on the user input.

The processor according to an embodiment of the disclosure may be further configured to execute the one or more instructions to control the memory to store the actual size information acquired based on the user input, as actual size data for the at least one object.

According to another embodiment of the disclosure, an operating method of an image display apparatus includes acquiring actual size information of at least one object included in image content, and displaying the at least one object in its actual size based on the actual size information of the at least one object.

According to another embodiment of the disclosure, a non-transitory recording medium storing a program for executing an operating method which includes acquiring actual size information of at least one object included in image content, and displaying the at least one object in its actual size based on the actual size information of the at least one object.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows an image display apparatus according to an embodiment of the disclosure;

FIG. 2 is a block diagram showing a configuration of an image display apparatus according to an embodiment of the disclosure;

FIG. 3 is a flowchart illustrating an operating method of an image display apparatus according to an embodiment of the disclosure;

FIG. 4 is a flowchart illustrating a method of acquiring actual size information of at least one object in which the method is performed by an image display apparatus according to an embodiment of the disclosure;

FIG. 5 is a reference view for describing the method illustrated in FIG. 4;

FIG. 6 is a flowchart illustrating a method of acquiring actual size information of at least one object in which the method is performed by an image display apparatus according to an embodiment of the disclosure;

FIG. 7 is a reference view for describing the method illustrated in FIG. 6;

FIG. 8 is a reference view for describing the method illustrated in FIG. 6;

FIG. 9 is a reference view for describing the method illustrated in FIG. 6;

FIG. 10 is a reference view for describing a method of displaying at least one object included in image content in its actual size in which the method is performed by an image display apparatus according to an embodiment of the disclosure;

FIG. 11 is a reference view for describing a method of displaying at least one object included in image content in its actual size in which the method is performed by an image display apparatus according to an embodiment of the disclosure; and

FIG. 12 is a block diagram showing a configuration of an image display apparatus according to another embodiment of the disclosure.

### DETAILED DESCRIPTION

Terms used in this specification will be briefly described, and the disclosure will be described in detail.

Although general terms being widely used in the disclosure were selected as terminology used in the disclosure while considering the functions of the disclosure, they may vary according to intentions of one of ordinary skill in the art, judicial precedents, the advent of new technologies, and the like. Terms arbitrarily selected by the applicant of the disclosure may also be used in a specific case. In this case, their meanings need to be given in the detailed description of the disclosure. Hence, the terms must be defined based on the meanings of the terms and the contents of the entire specification, not by simply stating the terms themselves.

It will be understood that when the terms “includes,” “comprises,” “including,” and/or “comprising,” when used in this specification, specify the presence of stated elements and/or components, but do not preclude the presence or addition of one or more elements and/or components thereof. As used herein, the terms “portion”, “module”, etc. refers to a unit that performs at least one function or operation, and may be implemented as a software or hardware or as a combination of software and hardware.

Throughout the disclosure, the expression “at least one of a, b or c” indicates only a, only b, only c, both a and b, both a and c, both b and c, all of a, b, and c, or variations thereof.

Hereinafter, embodiments of the disclosure will be described in detail with reference to the accompanying drawings so that the disclosure may be readily implemented by those skilled in the art. However, the disclosure is not limited to the following embodiments of the disclosure and may be implemented in different forms. In the drawings, parts irrelevant to the description are omitted for the simplicity of explanation, and through the whole specification, similar portions will be assigned similar reference numerals.

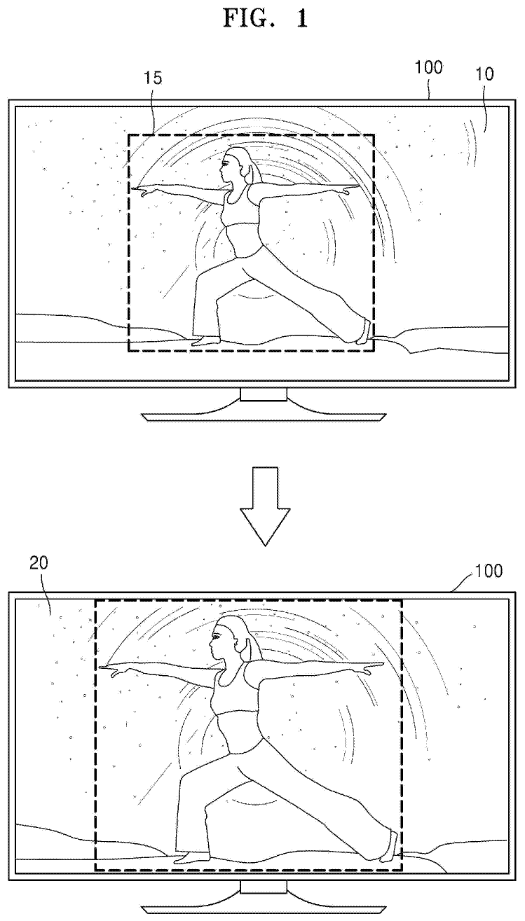

FIG. 1 shows an image display apparatus according to an embodiment of the disclosure.

An image display apparatus 100 according to an embodiment of the disclosure may be a TV, although not limited thereto. However, the image display apparatus 100 may be implemented in various forms including a display. For example, the image display apparatus 100 may be implemented as various electronic devices, such as a mobile phone, a tablet PC, a digital camera, a camcorder, a laptop computer, a desktop computer, an e-book terminal, a digital broadcasting terminal, Personal Digital Assistants (PDA), a Portable Multimedia Player (PMP), a navigation system, a MP3 player, a wearable device, etc. Particularly, the embodiments of the disclosure may be easily implemented in an image display apparatus with a large display such as a signage or a TV, although not limited thereto. Also, the image display apparatus 100 may be a fixed type or a mobile type, and may be a digital broadcasting receiver capable of receiving digital broadcasting.

In the embodiments of the disclosure of this specification, the term “user” means a person who controls functions or operations of the image display apparatus 100, and may include a manager or an installation engineer.

The image display apparatus 100 according to an embodiment of the disclosure may display first image content 10. The first image content 10 may include at least one object 15, and the image display apparatus 100 may acquire actual size information of the at least one object 15 included in the first image content 10.

For example, the image display apparatus 100 may perform image analysis on the first image content 10 to determine that the object 15 included in the first image content 10 is an “adult woman”, as shown in FIG. 1. The image display apparatus 100 may have stored actual size information of the “adult woman” in advance. In this case, the image display apparatus 100 may extract the actual size information of the “adult woman” stored in advance to acquire the actual size information of the “adult woman” object 15 included in the first image content 10.

Also, the image display apparatus 100 may analyze similarity between the first image content 10 and one or more images stored in advance together with actual size information to detect an image that is similar to the object 15 included in the first image content 10. The image display apparatus 100 may acquire actual size information of the object 15 included in the first image content 10, based on actual size information of the detected similar image.

Also, the image display apparatus 100 may transmit the first image content 10 to an external device (not shown). The external device (not shown) may perform image analysis on the first image content 10 to determine that the object 15 included in the first image content 10 is an “adult woman”, search for actual size information of the “adult woman”, and then transmit the actual size information of the “adult woman” to the image display apparatus 100.

The image display apparatus 100 may display the object 15 included in the first image content 10 in its actual size, based on the actual size information of the object 15 included in the first image content 10. For example, referring to FIG. 1, the image display apparatus 100 may display second image content 20 in which the “adult woman” object 15 is adjusted to the actual size (a second size), based on the actual size information of the “adult woman” object 15 in the first image content 10 including the “adult woman” object 15 displayed in a first size.

Meanwhile, the image display apparatus 100 according to an embodiment of the disclosure may display at least one object included in image content in its actual size when an actual size display mode operates. For example, when the image display apparatus 100 operating in a normal mode receives a user input requesting the actual size display mode, the image display apparatus 100 may operate in the actual size display mode in response to the user's request, although not limited thereto.

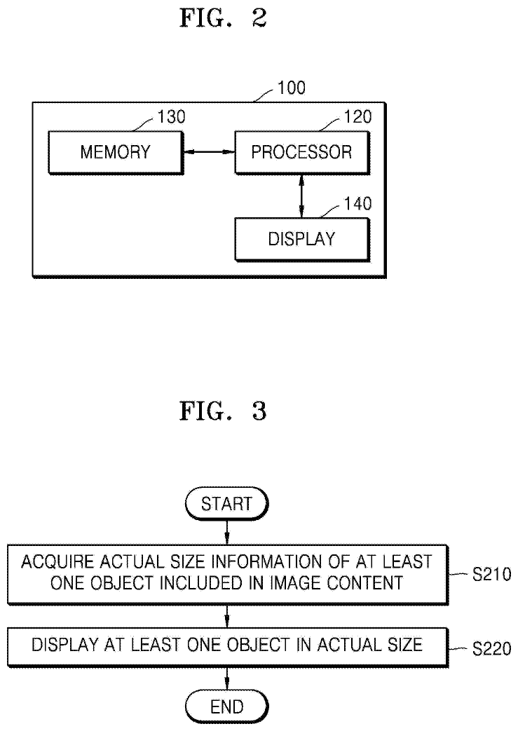

FIG. 2 is a block diagram showing a configuration of an image display apparatus according to an embodiment of the disclosure.

Referring to FIG. 2, the image display apparatus 100 according to an embodiment of the disclosure may include a processor 120, a memory 130, and a display 140.

The processor 120 according to an embodiment of the disclosure may execute one or more programs stored in the memory 130. The processor 120 may include a single core, a dual core, a triple core, a quad core and multiple cores thereof. Also, the processor 120 may include a plurality of processors. For example, the processor 120 may be implemented as a main processor (not shown) and a sub processor (not shown) operating in a sleep mode.

The memory 130 according to an embodiment of the disclosure may store various data, a program or an application for driving and controlling the image display apparatus 100.

Also, the program stored in the memory 130 may include one or more instructions. The program (one or more instructions) or application stored in the memory 130 may be executed by the processor 120.

The processor 120 according to an embodiment of the disclosure may execute one or more instructions stored in the memory 130 to acquire actual size information of at least one object included in image content. For example, the processor 120 may perform image analysis to determine a kind of at least one object included in image content, and acquire actual size information of the at least one object based on the determined kind of the at least one object. Also, the processor 120 may perform image analysis to detect an image that is similar to the at least one object from among images stored together with actual size information, and acquire actual size information of the at least one object based on actual size information corresponding to the detected image.

Also, the processor 120 may perform image analysis to extract actual size information of the at least one object in the image content.

Also, the processor 120 may determine an actual size of the at least one object based on an image in which the at least one object and a reference object are imaged together and actual size information of the reference object. The reference object may be a pre-set object, and include one or more markers displayed on the display 140 or objects having a standard specification and being in daily use, although not limited thereto.

Also, the processor 120 may acquire actual size information of the at least one object based on a user input.

Also, the processor 120 according to an embodiment of the disclosure may execute one or more instructions stored in the memory 130 to control the display 140 to display the at least one object in the actual size based on the acquired actual size information. The processor 120 may control the display 140 to display the at least one object in the actual size in consideration of a size of the display 140, a size of the image content displayed on the display 140, a ratio of the size of the object with respect to the size of the image content, a size of pixels constructing the image displayed on the display 140, etc.

For example, the processor 120 may enlarge or reduce the image content to adjust a size of the at least one object included in the image content such that the at least one object is displayed in the actual size. Also, the processor 120 may extract the at least one object from the image content, enlarge or reduce a size of the at least one object, then synthesize the at least one object with a background part of the image content, and display the result of the synthesis on the display 140. However, the processor 120 may adjust the size of the object displayed on the display 140 by using various methods.

The display 140 according to an embodiment of the disclosure may convert an image signal, a data signal, an OSD signal, a control signal, etc., processed by the processor 120, to generate a driving signal. The display 140 may be implemented as a plasma display panel (PDP) display, a liquid crystal display (LCD), an organic light emitting diodes (OLED) display, a flexible display, etc. Also, the display 140 may be implemented as a 3Dimensional (3D) display. Also, the display 140 may be configured with a touch screen to be used as an inputter as well as an outputter.

The display 140 according to an embodiment of the disclosure may display the at least one object included in the image content under the control of the processor.

FIG. 3 is a flowchart illustrating an operating method of an image display apparatus according to an embodiment of the disclosure.

Referring to FIG. 3, the image display apparatus 100 according to an embodiment of the disclosure may acquire actual size information of at least one object included in image content in operation S210.

For example, the image display apparatus 100 may perform image analysis to determine a kind of at least one object included in image content, and acquire actual size data corresponding to the kind of the object to thereby acquire actual size information of the object. Also, the image display apparatus 100 may detect an image that is similar to the at least one object, and acquire actual size data corresponding to the detected image to thereby acquire actual size information of the object.

Also, the image display apparatus 100 may acquire actual size information of the at least one object, based on an image in which the at least one object and a reference object whose actual size has been known are imaged together.

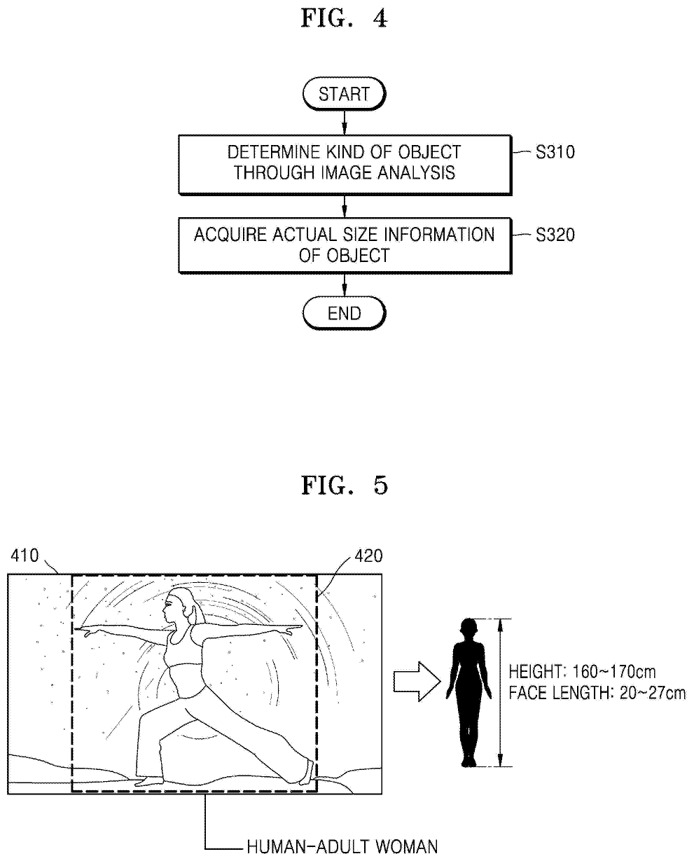

A method in which the image display apparatus 100 acquires actual size information will be described in detail with reference to FIGS. 4 to 10.

The image display apparatus 100 may display the at least one object included in the image content in the actual size in operation S220.

The image display apparatus 100 may adjust a size of the at least one object to display the at least one object in the actual size in consideration of a size of the display 140, a size of the image content displayed on the display 140, a ratio of the size of the object with respect to the size of the image content, a size of pixels constructing the image displayed on the display 140, etc.

For example, the image display apparatus 100 may enlarge or reduce the image content to adjust a size of the at least one object included in the image content such that the at least one object is displayed in its actual size on the display 140. Also, the image display apparatus 100 may extract the at least one object from the image content, enlarge or reduce a size of the at least one object, then synthesize the at least one object with a background part of the image content, and display the result of the synthesis on the display 140. However, the image display apparatus 100 may adjust the size of the object displayed on the display 140 by using various methods.

FIG. 4 is a flowchart illustrating a method of acquiring actual size information of at least one object in which the method is performed by an image display apparatus according to an embodiment of the disclosure, and FIG. 5 is a reference view for describing the method illustrated in FIG. 4.

Referring to FIG. 4, the image display apparatus 100 may determine a kind of at least one object included in image content through image analysis in operation S310.

The image display apparatus 100 may extract a feature of the at least one object included in the image content, and determine a kind of the object based on the extracted feature of the object. At this time, the image display apparatus 100 may use various algorithms or models for extracting features from images. Also, data in which features of images match with kinds (for example, names, tag information, etc.) of the images may have been stored in advance in the image display apparatus 100.

For example, referring to FIG. 5, the image display apparatus 100 may extract a feature from an object 420 included in an image 410 by using a feature extracting algorithm or a feature extracting model, and determine that the object 420 is a “human-adult woman” based on the extracted feature.

Also, the image display apparatus 100 may extract an image that is similar to the at least one object from among one or more images whose kinds have already been determined, based on the feature of the at least one object. The one or more images may have been stored in advance in the image display apparatus 100 together with the kinds (for example, names, tag information, etc.) of the images. The image display apparatus 100 may determine a kind of the at least one object based on the kind of the similar image. For example, when a name of an image determined to be similar to the object is “dog”, the image display apparatus 100 may determine the at least one object as a “dog” object.

The image display apparatus 100 may acquire actual size information of the object based on the kind of the object in operation S320.

For example, one or more objects and actual size information of the objects may have been stored in advance in the image display apparatus 100. In this case, the image display apparatus 100 may extract actual size information corresponding to the determined kind of the object from the information stored in advance.

Also, the image display apparatus 100 may transmit the determined kind of the object to an external device, and receive actual size information corresponding to the kind of the object from the external device. In this case, the external device may include database in which one or more objects and actual size information of the objects are stored.

For example, as shown in FIG. 5, the image display apparatus 100 may search for actual size information of “adult-woman” in a local storage (database) to acquire the actual size information of the “adult-woman”, or may acquire actual size information of the “adult-woman” from an external device. Herein, the actual size information of the “adult-woman” may include height data (160 cm to 170 cm) of the “adult-woman” and face length data (20 cm to 27 cm) of the “adult-woman”.

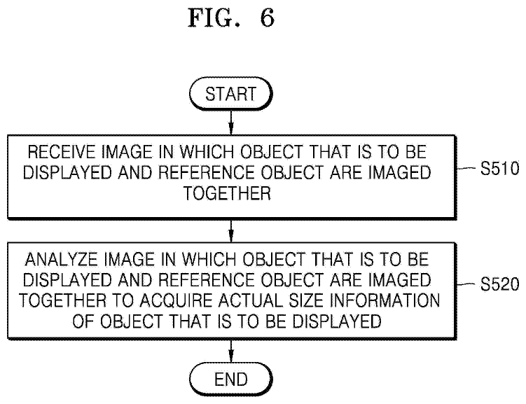

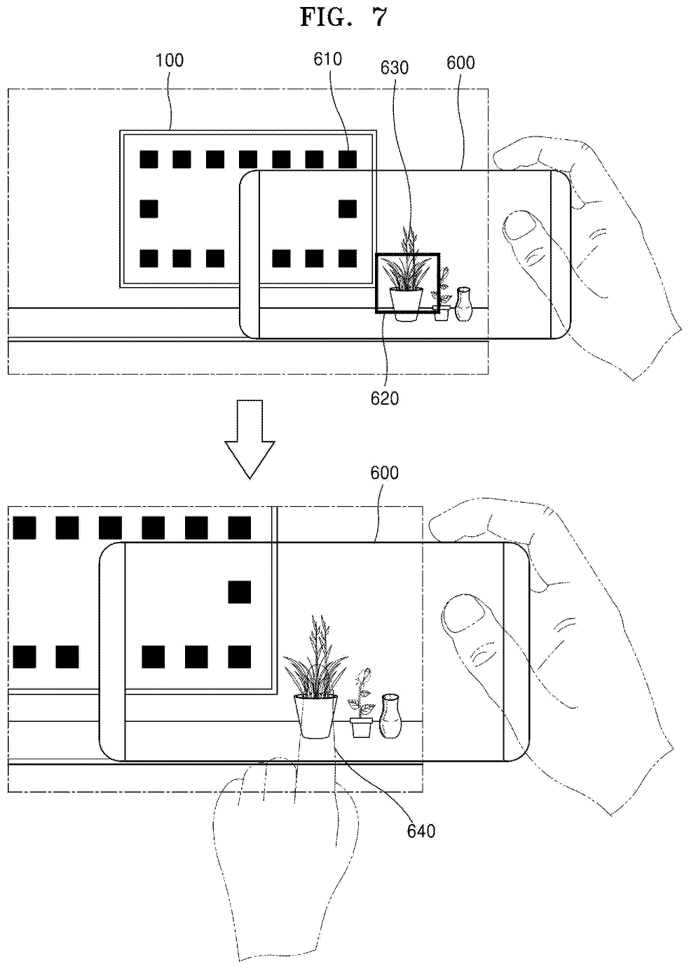

FIG. 6 is a flowchart illustrating a method of acquiring actual size information of at least one object in which the method is performed by an image display apparatus according to an embodiment of the disclosure, and FIGS. 7 to 9 are reference views for describing the method illustrated in FIG. 6.

Referring to FIG. 6, an image display apparatus according to an embodiment of the disclosure may receive an image in which an object that is to be displayed on a display and a reference object are imaged together in operation S510.

According to an embodiment of the disclosure, the object that is to be displayed on the display and the reference object may have been imaged together by an external device. The external device may be an electronic device including a camera, or a mobile terminal, as shown in FIG. 7, although not limited thereto.

The reference object according to an embodiment of the disclosure may be a pre-set object. Referring to FIG. 7, the reference object may be one or more markers 610 that are displayed on the display 140. For example, the image display apparatus 100 may display the one or more markers 610 on the display 140 based on a user input. Shapes, sizes, and locations of the one or more markers 610 that are displayed on the display 140 may have been set in advance.

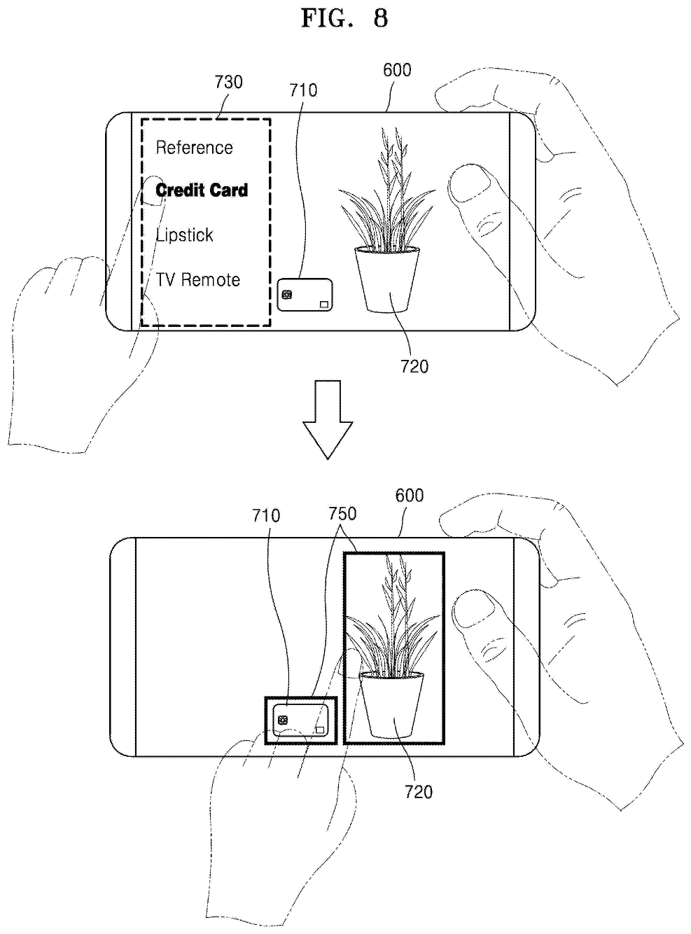

Also, referring to FIG. 8, the reference object may be articles having a standard specification and being in daily use. For example, the reference object may be a credit card, a lipstick, a remote controller, a paper cup, a piece of A4 paper, etc., although not limited thereto.

For example, an external device 600 may image a reference object and an object that is to be displayed on a display, together, to generate an image and transmit the image to the image display apparatus 100.

The image display apparatus 100 according to an embodiment of the disclosure may analyze the image in which the object that is to be displayed on the display and the reference object are imaged together, based on the actual size information of the reference object, to acquire actual size information of the object that is to be displayed on the display in operation S520.

For example, the external device 600 may calculate an actual size of the object that is to be displayed on the display, based on an actual size of the reference object, a size of the reference object in the image, a size of the object that is to be displayed on the display in the image, a positional relation between the reference object and the object that is to be displayed on the display in the image, etc., although not limited thereto.

Referring again to FIG. 7, the image display apparatus 100 may display the one or more markers 610 on the display. For example, the image display apparatus 100 may display the one or more markers 610, based on a user input (for example, an input requesting a marker display mode).

FIG. 7 shows a case in which each of the one or more markers 610 is in the shape of a square, however, the one or more markers 610 may be displayed in various shapes. Also, shapes, sizes, positions, etc. of the one or more markers 610 may have been set in advance.

A user may image the one or more markers 610 displayed on the display and an object (hereinafter, referred to as a target object) 630 that is to be displayed on the display, by using the external device 600, such that the one or more markers 610 and the target object 630 are included in an image. The external device 600 may be an electronic device including a camera. For example, the external device 600 may be implemented as various electronic devices, such as a mobile phone, a smart phone, a laptop computer, a tablet PC, a digital camera, a camcorder, a wearable device (for example, smart glass, etc.), etc., although not limited thereto.

The external device 600 according to an embodiment of the disclosure may communicate with the image display apparatus 100 to receive information about the one or more markers 610 from the image display apparatus 100. Also, the external device 600 may recognize the one or more markers 610 displayed on the display from an image received from the camera, based on the information about the one or more markers 610. The external device 600 may display a guide 620 for a position or area at which it will locate the target object 630, based on the positions of the recognized one or more markers 610. The external device 600 may determine the target object 630 located at a guided position or area as a target object (for example, a pot).

Also, the external device 600 may determine a target object based on a user input 640 of selecting a target object from the image. Also, the external device 600 may transmit the image and information about the selected target object to the image display apparatus 100.

The image display apparatus 100 may analyze the image received from the external device 600 to acquire actual size information of the target object 630.

For example, the image display apparatus 100 may calculate an actual size of the target object 630, based on actual sizes of the one or more markers 610 displayed on the display, a size of the target object 630 in the received image, sizes of the markers 610 in the received image, and a positional relation between the target object 630 and the markers 610 in the received image.

Meanwhile, referring to FIG. 8, the image display apparatus 100 may set a reference object for calculating an actual size of a target object. The reference object may be articles having a standard specification and being in daily use. For example, as shown in FIG. 8, the reference object may be a credit card, a lipstick, a remote controller, a paper cup, a piece of A4 paper, etc., although not limited thereto.

Also, the image display apparatus 100 may store size information of the reference object set in advance, such as a length of the reference object, a width of the reference object, an angle of the reference object, etc., as database. Also, the image display apparatus 100 may set an additional reference object based on a user input. For example, the image display apparatus 100 may receive a shape, size, etc. of a reference object that is to be added, from a user, and add the reference object as a new reference object.

The external device 600 according to an embodiment of the disclosure may communicate with the image display apparatus 100 to receive information about reference objects from the image display apparatus 100. The external device 600 may display a reference object list 730 including a plurality of reference objects on the display of the external device 600. The user may select a reference object 710 from the reference object list 730, and image the reference object (for example, a credit card) 710 and a target object (for example, a pot) 720 by using the external device 600 such that the reference object 710 and the target object 720 are included in an image.

At this time, the external device 600 may display a guide 750 for a position or area at which it will locate the reference object 710 and the target object 720, based on the selected reference object 710. The external device 600 may determine objects located at a guided position or area as the reference object 710 and the target object 720.

Also, the external device 600 may determine the reference object 710 and the target object 720 from the image, based on a user input of selecting a reference object and a target object from the image. Also, the external device 600 may transmit the image and information about the selected reference object 710 and the selected target object 720 to the image display apparatus 100.

The image display apparatus 100 may analyze the image received from the external device 600 to acquire actual size information of the target object 720.

For example, the image display apparatus 100 may calculate an actual size of the target object 720 based on an actual size of the reference object 710, a size of the target object 720 in the received image, a size of the reference object 710 in the received image, and a positional relation between the target object 720 and the reference object 710 in the received image.

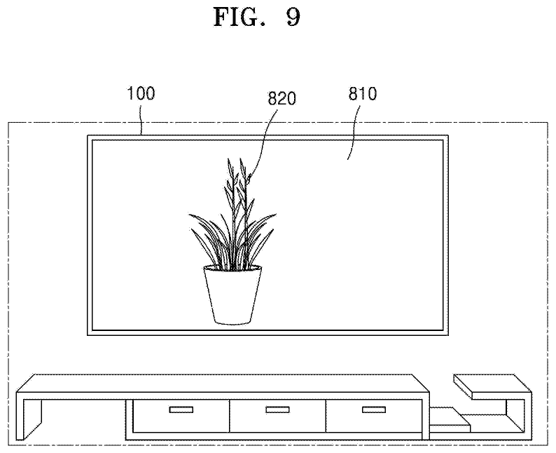

Referring to FIG. 9, the image display apparatus 100 according to an embodiment of the disclosure may display a target object 820 in its actual size on the display.

For example, the image display apparatus 100 may extract an image of the target object 820 from an image received from the external device 600, and adjust a size of the target object 820 such that the target object 820 is displayed in its actual size on the display.

The image display apparatus 100 may adjust a size of the target object 820 such that the target object 820 is displayed in its actual size in consideration of a size of the display of the image display apparatus 100, a size of image content that is displayed on the display, an actual size of the target object 820, the number of pixels constructing the display, a ratio of the size of the target object 820 with respect to the size of the image content, a size of an area represented by each of the pixels constructing the display, etc.

For example, when a horizontal length of entire image content 810 including a wall background image and a pot image that is to be displayed on the display is 160 cm, a vertical length of the entire image content 810 is 90 cm, an actual horizontal length of the “pot” is 40 cm, an actual vertical length of the “pot” is 45 cm, and the entire image content 810 is configured with pixels of 1600×900, the image display apparatus 100 may assign pixels of 400×450 to the target object 820 of the pot image and control the display to display the pot in a size of 40 cm×45 cm.

Also, when an area represented by each of the pixels constructing the display has a size of 1 mm×1 mm, pixels of 400×450 may be assigned to the target image 820 of pot image such that the pot is displayed in a size of 40 cm×45 cm on the display.

However, the image display apparatus 100 may enlarge or reduce a size of image content or an object by various methods to control the display to display the object in its actual size.

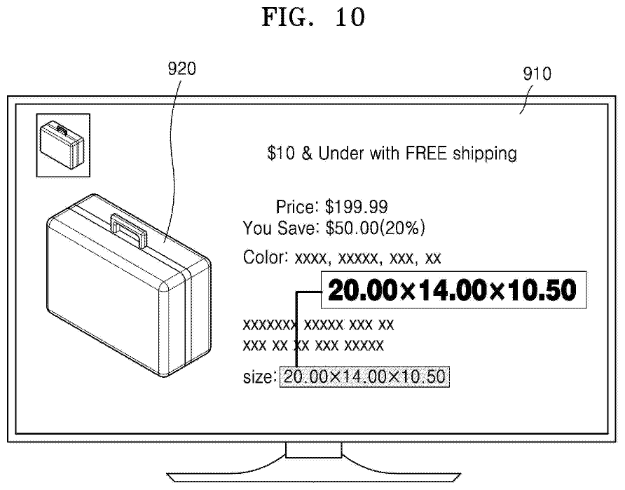

FIG. 10 is a reference view for describing a method of displaying at least one object included in image content in its actual size in which the method is performed by an image display apparatus according to an embodiment of the disclosure.

Referring to FIG. 10, the image display apparatus 100 may display a web page 910 related to shopping. The image display apparatus 100 may receive the web page 910 from a web server. The web page 910 may provide information about a product. For example, the information about the product may include an image of the product, a model name of the product, a price of the product, a color of the product, size information of the product, etc.

The image display apparatus 100 may extract size information (for example, 20.00×14.00×10.50) of the product from the web page 910 through image analysis on the web page 910, and acquire actual size information of the product based on the size information of the product.

Also, the image display apparatus 100 may receive size information of the product from a web server, and acquire actual size information of the product based on the size information of the product.

The image display apparatus 100 may display a product 920 included in a web page in its actual size, based on the actual size information of the product 920.

For example, when the image display apparatus 100 receives a user input requesting an actual size display mode, the image display apparatus 100 may enlarge or reduce an image of the product 920 displayed on the web page to adjust a size of the product 920 such that the product 920 is displayed in its actual size.

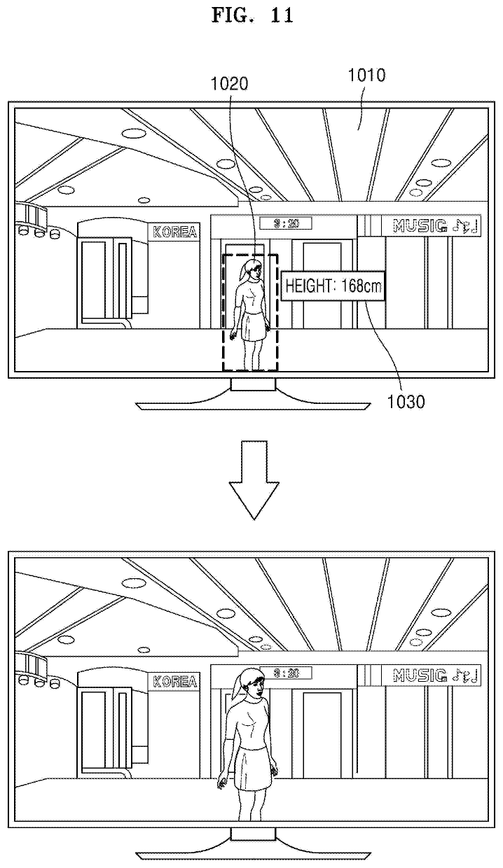

FIG. 11 is a reference view for describing a method of displaying at least one object included in image content in its actual size in which the method is performed by an image display apparatus according to an embodiment of the disclosure.

Referring to FIG. 11, the image display apparatus 100 may display image content 1010. The image content 1010 may include at least one object 1020. At this time, the at least one object 1020 may be displayed in its actual size. For example, the image display apparatus 100 may automatically acquire actual size information of the at least one object 1020 included in the image content 1010 by using the methods described above with reference to FIGS. 4 to 10. Accordingly, the image display apparatus 100 may display the at least one object 1020 in its actual size on the display.

Also, the image display apparatus 100 may receive an input of selecting the at least one object 1020 included in the image content 1010. For example, the image display apparatus 100 may receive an input of selecting an object from a controller. A controller according to an embodiment of the disclosure may be implemented as various types of devices, such as a remote controller or a mobile phone, for controlling the image display apparatus 100. Also, the controller may control the image display apparatus 100 by using short-range communication including Infrared communication or Bluetooth communication. The controller may control functions of the image display apparatus 100 by using at least one of a key (including a hard key button, a soft key, a scroll wheel, etc.), a touch pad, a microphone capable of receiving a user's voice, or a sensor capable of recognizing motions of the controller.

The image display apparatus 100 may receive size data 1030 of the selected object 1020. After the image display apparatus 100 receives the size data 1030 of the selected object 1020, the image display apparatus 100 may adjust a size of the selected object 1020 such that the selected object 1020 is displayed in the adjusted size on the display.

The image display apparatus 100 may enlarge or reduce the image content 1010, or may extract the object 1020 selected from the image content 1010 to enlarge or reduce a size of the extracted object 1020, then synthesize the enlarged or reduced object 1020 with a background part of the image content 1010, and display the result of the synthesis, although not limited thereto.

Also, the image display apparatus 100 may match a kind of the selected object 1020 with the received actual size of the object 1020 and store the result of the matching as database, or the image display apparatus 100 may match an image of the selected object 1020 with the received actual size of the object 1020 and store the result of the matching as database. Accordingly, the image display apparatus 100 may acquire actual size information of the same kind of object as that of the selected object 1020 or actual size information of an image that is similar to that of the selected object 1020, by using the stored database.

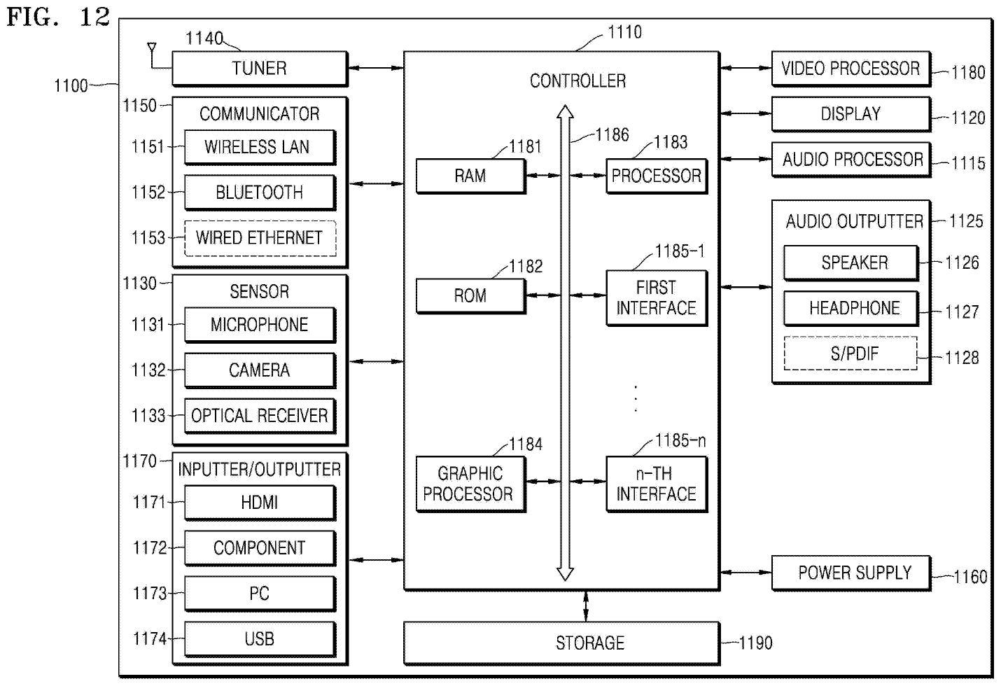

FIG. 12 is a block diagram showing a configuration of an image display apparatus according to another embodiment of the disclosure. An image display apparatus 1100 of FIG. 12 may be an example of the image display apparatus 100 of FIG. 1.

Referring to FIG. 12, the image display apparatus 1100 according to an embodiment of the disclosure may include a tuner 1140, a controller 1110, a display 1120, a communicator 1150, a sensor 1130, an inputter/outputter 1170, a video processor 1180, an audio processor 1115, a storage 1190, and a power supply 1160.

The tuner 1140 may tune a frequency of a channel which the image display apparatus 1100 intends to receive among radio wave components by amplifying, mixing, and resonating broadcasting signals received in a wired or wireless fashion, thus selecting the frequency of the channel. The broadcasting signals may include audio, video, and additional information (for example, Electronic Program Guide (EPG)).

The tuner 1140 may receive a broadcasting signal in a frequency band corresponding to a channel number according to a user input (for example, a control signal (e.g., a channel number input, a channel up/down input, and a channel input to an EPG screen) received from the controller 1110).

The tuner 1140 may receive a broadcasting signal from various sources, such as terrestrial broadcasting, cable broadcasting, satellite broadcasting, and Internet broadcasting, etc. The tuner 1140 may receive a broadcasting signal from a source such as analog broadcasting or digital broadcasting.

The communicator 1150 may transmit/receive data or a signal to/from an external device or a server under the control of the controller 1110. The controller 1110 may transmit/receive content to/from an external device connected through the communicator 1150, download an application from the external device, or perform web browsing. The communicator 1150 may transmit/receive data or a signal by using at least one of a wireless LAN (for example, Wi-Fi) 1151, Bluetooth 1152, or wired Ethernet 1153 in correspondence to the performance and structure of the image display apparatus 1100.

The video processor 1180 may process video data received by the image display apparatus 1100. The video processor 1180 may perform various image processing (for example, decoding, scaling, noise filtering, frame rate conversion, resolution conversion, etc.) on the video data.

The sensor 1130 may sense a user's voice, a user's image, or a user's interaction, and include a microphone 1131, a camera 1132, and an optical receiver 1133.

The microphone 1131 may receive a voice uttered from a user. The microphone 1131 may convert the received voice to an electrical signal, and output the electrical signal to the controller 1110. The user's voice may include a voice corresponding to a menu or function of the image display apparatus 1100.

The camera 1132 may receive an image (for example, successive frames) corresponding to a user's motion including a gesture in a camera recognition range. The controller 1110 may select a menu displayed on the image display apparatus 1100 based on the recognition result of the received motion, or perform a control operation corresponding to the recognition result of the motion.

The optical receiver 1133 may receive an optical signal (including a control signal) from an external controller through a light window (not shown) of a bezel of the display 1120. The optical receiver 1133 may receive an optical signal corresponding to a user input (for example, a touch, pressing, a touch gesture, a voice or a motion) from the external controller. A control signal may be extracted from the received optical signal under the control of the controller 1110.

The inputter/outputter 1170 may receive video (for example, moving images), audio (for example, a voice, music, etc.) and additional information (for example, EPG, etc.) from the outside of the image display apparatus 1100 under the control of the controller 1110. The inputter/outputter 1170 may include one of a High-Definition Multimedia Interface (HDMI) port 1171, a component jack 1172, a PC port 1173, and a USB port 1174. The inputter/outputter 1170 may include a combination of the HDMI port 1171, the component jack 1172, the PC port 1173, and the USB port 1174.

The controller 1110 may control all operations of the image display apparatus 1100 and a signal flow between internal components of the image display apparatus 1100, and perform a function of processing data. When the controller 1110 receives a user input or a predetermined, stored condition is satisfied, the controller 1110 may execute an operating system (OS) and various applications stored in the storage 1190.

The controller 1110 may include RAM 1181 storing a signal or data received from the outside of the image display apparatus 1100 or used as a storage area corresponding to various tasks performed by the image display apparatus 1100, ROM 1182 storing control programs for controlling the image display apparatus 1100, and a processor 1183.

A graphic processor 1184 may create a screen including various objects such as an icon, an image, text, etc., by using an operator (not shown) and a renderer (not shown). The operator may calculate an attribute value such as coordinate values, a shape, a size, a color, etc., with which each object will be displayed according to a layout of the screen, by using a user input sensed through the sensor 1130. The renderer may create a screen of various layouts including the objects, based on the attribute value calculated by the operator. The screen created by the renderer may be displayed in a display area of the display 1120.

First and n-th interfaces 1185-1 to 1185-n may be connected to the above-described various components. One of the first to n-th interfaces 1185-1 to 1185-n may be a network interface that is connected to an external device through a network.

The RAM 1181, the ROM 1182, the processor 1183, the graphic processor 1184, the first to n-th interfaces 1185-1 to 1185-n may be connected to each other through an internal bus 1186.

In the current embodiment of the disclosure, the term “controller of an image display apparatus” may include the processor 1183, the ROM 1182, and the RAM 1181.

The display 1120 may convert an image signal, a data signal, an OSD signal, a control signal, etc. processed by the controller 1110 to generate a driving signal. The display 1120 may be implemented as a PDP display, a LCD, an OLED display, a flexible display, etc., and also, the display 1120 may be implemented as a 3D display. Also, the display 1120 may be configured with a touch screen to be used as an inputter as well as an outputter.

The audio processor 1115 may process audio data. The audio processor 1115 may perform various processing on audio data, such as decoding, amplification, noise filtering, etc. Meanwhile, the audio processor 1115 may include a plurality of audio processing modules for processing audio corresponding to a plurality of contents.

The audio outputter 1125 may output audio included in a broadcasting signal received through the tuner 1140 under the control of the controller 1110. The audio outputter 1125 may output audio (for example, a voice or sound) received through the communicator 1150 or the inputter/outputter 1170. Also, the audio outputter 1125 may output audio stored in the storage 1190 under the control of the controller 1110. The audio outputter 1125 may include at least one of a speaker 1126, a headphone output terminal 1127, or a Sony/Philips Digital Interface (S/PDIF) output terminal 1128. The audio outputter 1125 may include a combination of the speaker 1126, the headphone output terminal 1127, and the S/PDIF output terminal 1128.

The power supply 1160 may supply a voltage received from an external power source to the internal components of the image display apparatus 1100 under the control of the controller 1110. Also, the power supply 1160 may supply a voltage output from one, two, or more batteries (not shown) located in the inside of the image display apparatus 1100 to the internal components under the control of the controller 1110.

The storage 1190 may store various data, programs, or applications for driving and controlling the image display apparatus 1100 under the control of the controller 1110. The storage 1190 may include a broadcasting receiving module, a channel control module, a volume control module, a communication control module, a voice recognition module, a motion recognition module, an optical receiver module, a display control module, an audio control module, an external input control module, a power control module, a power control module of an external device connected in a wireless fashion (for example, Bluetooth), voice database (DB), or motion DB. The modules (not shown) and database (not shown) of the storage 1190 may be implemented in the form of software to perform a broadcasting reception control function, a channel control function, a volume control function, a communication control function, a voice recognition function, a motion recognition function, an optical reception control function, a display control function, an audio control function, an external input control function, a power control function, or a function of controlling power of an external device connected in a wireless fashion (for example, Bluetooth) to the image display apparatus 1100. The controller 1110 may perform the individual functions by using the software stored in the storage 1190.

Meanwhile, the block diagrams of the image display apparatuses 100 and 1100 shown in FIGS. 2 and 12 are block diagrams according to embodiments of the disclosure. The components shown in the block diagrams may be integrated into one component, another component may be added to the image display apparatuses 100 and 1100, or some of the components may be omitted, according to specifications of the image display apparatuses 100 and 1100. That is, two or more components may be integrated into one component, or one component may be divided to two or more components, as necessary. Also, a function performed in each block is given to describe the embodiments of the disclosure, and a detailed operation or apparatus thereof will not limit the scope of a right of the disclosure.

The image display apparatus according to an embodiment of the disclosure can display objects included in image content in their actual sizes, thereby increasing a sense of immersion as if the objects exist in actual space.

The image display apparatus according to an embodiment of the disclosure can provide information about objects more realistically so that users can receive feelings and information about the objects more accurately and easily.

An operating method of the image display apparatus according to an embodiment of the disclosure may be implemented in the form of program commands that may be executed through various computer means, and recorded on a computer-readable medium. The computer-readable medium may include, alone or in combination with the program commands, data files, data structures, and the like. The program commands recorded on the medium may be those specially designed and constructed for the purposes of the disclosure, or they may be of the kind well-known and available to those having skill in the computer software arts. Examples of the computer-readable medium include magnetic media such as hard disks, floppy disks, and magnetic tape; optical media such as CD ROM disks and DVDs; magneto-optical media such as optical disks; and hardware devices that are specially configured to store and perform program commands, such as ROM, RAM, flash memory, and the like. Examples of program commands include both machine code, such as produced by a compiler, and higher level code that may be executed by the computer using an interpreter.

Also, the operating method of the image display apparatus according to the disclosed embodiment of the disclosure may be included in a computer program product and provided. The computer program product may be traded as goods between a seller and a purchaser.

The computer program product may include a software program or a non-transitory computer-readable recording medium storing software programs. For example, the computer program product may include a product (for example, downloadable App) in the form of a software program that is electronically distributed through a manufacturing company or an electronic market (for example, Google Play Store or App Store) of the image display apparatus. For electronic distribution, at least one part of software programs may be stored in a recording medium or temporarily created. In this case, the recording medium may be a recording medium of a server of a manufacturing company, a server of an electronic market, or a relay server that temporarily stores software programs.

The computer program product may include, in a system configured with a server and a client device, a recording medium of the server or a recording medium of the client device. Also, when there is a third device (for example, a smart phone) communicating with the server or the client device, the computer program product may include a recording medium of the third device. Also, the computer program product may include a software program itself that is transmitted from the server to the client device or the third device or from the third device to the client device.

In this case, one of the server, the client device and the third device may execute the computer program product to perform the method according to the embodiments of the disclosure. Also, two or more of the server, the client device and the third device may execute the computer program product to perform the method according to the embodiments of the disclosure in a distributed manner.

For example, a server (for example, a cloud server or an artificial intelligence server) may execute the computer program product stored in the server to control a client device communicating with the server to perform the method according to the embodiments of the disclosure.

While one or more embodiments of the disclosure have been described in detail, it will be understood by those of ordinary skill in the art that various changes in form and details may be made therein without departing from the spirit and scope of the disclosure as defined by the following claims.

What is claimed is:

1. An image display apparatus comprising:
a display displaying image content;
a memory storing one or more instructions; and
a processor configured to execute the one or more instructions stored in the memory,
wherein the processor is configured to execute the one or more instructions:
to acquire actual size information of at least one object included in the image content, and
to control the display to display the at least one object in its actual size based on the actual size information.

2. The image display apparatus of claim 1, wherein the processor is further configured to execute the one or more instructions to perform image analysis to determine a kind of the at least one object, and acquire the actual size information of the at least one object based on the kind of the at least one object.

3. The image display apparatus of claim 1, wherein the processor is further configured to execute the one or more instructions to perform image analysis to detect an image that is similar to the at least one object from among one or more images stored together with actual size information, and extract the actual size information of the at least one object based on actual size information corresponding to the detected image.

4. The image display apparatus of claim 1, wherein the processor is further configured to execute the one or more instructions to perform image analysis to extract the actual size information of the at least one object in the image content.

5. The image display apparatus of claim 1, wherein the processor is further configured to execute the one or more instructions to receive an image in which the at least one object and a reference object are imaged together, and determine an actual size of the at least one object based on actual size information of the reference object and the received image.

6. The image display apparatus of claim 5, wherein the reference object includes one or more screen markers that are displayed on the display, and
the processor is further configured to execute the one or more instructions to set sizes of the one or more screen markers and positions of the one or more screen markers that are to be displayed on the display.

7. The image display apparatus according to claim 1, wherein the processor is further configured to execute the one or more instructions to receive a user input of selecting an actual size display mode, and control the display to display the at least one object included in the image content in the actual size.

8. The image display apparatus according to claim 1, wherein the processor is further configured to:
execute the one or more instructions to acquire the actual size information of the at least one object based on a user input; and
control the display to display the at least one object in the actual size according to the actual size information acquired based on the user input.

9. The image display apparatus according to claim 8, wherein the processor is further configured to execute the one or more instructions to control the memory to store the actual size information acquired based on the user input, as actual size data for the at least one object.

10. An operating method of an image display apparatus, the operating method comprising:
acquiring actual size information of at least one object included in image content; and
displaying the at least one object in its actual size based on the actual size information of the at least one object.

11. The operating method of claim 10, wherein the acquiring of the actual size information of the at least one object comprises:
performing image analysis to determine a kind of the at least one object; and
acquiring the actual size information of the at least one object based on the kind of the at least one object.

12. The operating method of claim 10, wherein the acquiring of the actual size information of the at least one object comprises:
performing image analysis to detect an image that is similar to the at least one object from among one or more images stored together with actual size information; and
extracting the actual size information of the at least one object based on actual size information corresponding to the detected image.

13. The operating method of claim 10, wherein the acquiring of the actual size information of the at least one object comprises performing image analysis to extract the actual size information of the at least one object in the image content.

14. The operating method of claim 10, wherein the acquiring of the actual size information of the at least one object comprises:
receiving an image in which the at least one object and a reference object are imaged together; and
determining an actual size of the at least one object based on actual size information of the reference object and the received image.

15. The operating method of claim 14, wherein the reference object includes one or more screen markers that are displayed on a display,
the operating method further comprising:
setting sizes of the one or more screen markers and positions of the one or more screen markers that are to be displayed on the display; and
displaying the one or more screen markers.

16. The operating method of claim 10, further comprising receiving a user input of selecting an actual size display mode.

17. The operating method of claim 10, wherein the acquiring of the actual size information of the at least one object comprises acquiring the actual size information of the at least one object based on a user input, and
the displaying of the at least one object in the actual size comprises displaying the at least one object in the actual size according to the actual size information acquired based on the user input.

18. The operating method of claim 17, further comprising storing the actual size information acquired based on the user input, as actual size data for the at least one object.

19. A non-transitory computer-readable recording medium storing a program for executing the operating method of claim 10 on a computer.
